(19) United States
(12) Patent Application Publication
(10) Pub. No.: US 2008/0157420 A1
(43) Pub. Date: Jul. 3, 2008

(54) Filter Housing and Method for Manufacturing the Same

(75) Inventor: Gerhard MAYER, Pleidelsheim (DE)

Correspondence Address: CROWELL & MORING LLP;INTELLECTUAL PROPERTY GROUP, P.O. BOX 14300, WASHINGTON, DC, 20044-4300, US

(73) Assignee: MANN+HUMMEL GmbH, Ludwigsburg (DE)

(21) Appl. No.: 11/766,554

(22) Filed: Jun. 21, 2007

Related U.S. Application Data
(62) Division of application No. 11/454,787, filed on Jun. 19, 2006, now abandoned.
Application No. 11/454,787 is a continuation of application No. PCT/EP04/53600, filed on Dec. 20, 2004.

(30) Foreign Application Priority Data
Dec. 20, 2003 (DE) 103 60 230.5

(51) Int. Cl. B29C 39/00; B29C 35/02

(52) U.S. Cl. 264/157; 264/319; 264/331.15

(57) ABSTRACT

A filter housing, in particular for an air filter for the air intake tract of an internal combustion engine, in which the filter housing (16) includes at least one upper housing section (12) and at least one lower housing section (11) which can be assembled to each other in a sealed manner. The housing sections (11, 12) are produced as centrifugally cast parts and have a geometrically defined outer face (A) and a geometrically defined inner face (I) configured such that the outer face of one of the housing sections (11, 12) can be connected to the inner face of the other housing section, whereby the housing sections can be manufactured in a cost-effective manner and can fit one another snugly.

### CROSS-REFERENCE TO RELATED APPLICATIONS

This application is a division of co-pending application Ser. No. 11/454,787, filed Jun. 19, 2006, which in turn is a continuation of international patent application no. PCT/EP2004/053600, filed Dec. 20, 2004, designating the United States of America, and published in German on Jul. 7, 2005, as WO 2005/061880, the entire disclosure of which is incorporated herein by reference. Priority is claimed based on Federal Republic of Germany patent application no. DE 103 60 230.5, filed Dec. 20, 2003.

### BACKGROUND OF THE INVENTION

The present invention relates to a filter housing and a method for manufacturing a filter housing. In particular, the invention relates to a filter housing for an air filter for filtering the intake air of an internal combustion engine.

Filter housings are typically produced by injection molding. In injection molding, the upper and the lower part of the housing are produced with separate molds. The thermoplastic molding compounds (powders, granules, pellets, pastes, etc.), are heated (to approximately 180° C.) until liquefied and subsequently injected under high pressure (up to 1400 bar) into closed, two-part, water-cooled, hollow steel molds, in which they cool and solidify. Molding compounds are used include polystyrene, polyamides, polyurethanes, cellulose ethers and cellulose esters, polyethylene, polymethacrylates and other thermoplastics, duroplastics which cure in the mold, vulcanizable rubber or silicon rubber elastomers, and to some extent also expanded plastics.

Air filter housings must have a tight seal between the two housing sections, so that no unfiltered air can flow from the unfiltered side of the filter to the filtered side. But even in other applications it is useful and advantageous to close a housing with a cover as airtightly as possible. For this purpose, seals are conventionally used in the region of the contact surface between the lid and the housing shell. Especially in plastic housings, there is a risk that the material may warp during manufacture of the housing, such that tolerances may, under certain circumstances, cause leaks between the two housing parts.

Known measures taken in the past to prevent leaks have included reinforcing the parts in the seal area, e.g., by material accumulations or by using stiffening elements, some of which were made of a metallic material. However, the use of material accumulation, especially in plastics, tends to increase warping. The use of metallic stiffening elements, on the other hand, has the drawback that the plastic cannot be recycled or recycling is made substantially more difficult.

European patent no. 726,389 has already proposed to provide one or both plastic parts with at least one channel closed on all sides, which increases the strength as well as the maximum allowable bending stress. This channel is formed using gas-assisted injection molding. In this process, in a single injection molding operation, the plastic material is first injected into the mold, and air is subsequently injected into the channel to be formed either through the injection nozzle or an additional nozzle, to create an air-containing channel.

However, because this method also uses injection molding, two separate molds are required for the upper part and the lower part of the filter housing. The molds are very expensive because of the air nozzle.

### SUMMARY OF THE INVENTION

Accordingly, it is an object of the invention to provide a new type of molded filter housing.

Another object of the invention is to provide an improved method for manufacturing a filter housing.

A further object of the invention is to provide a method for manufacturing a filter housing having both an adequate seal and sufficient rigidity in a simple and cost-effective manner.

These and other objects are achieved in accordance with the present invention by providing a filter housing including at least one upper housing section and at least one lower housing section; the upper and lower housing sections being connectable to each other to form a sealed chamber for receiving a filter insert, wherein the housing sections are produced by centrifugal casting such that the housing parts have a geometrically defined outer surface and a geometrically undefined inside surface, and such that the outside surface of one of the housing sections is connected to the outside or the inside of the other housing section.

In accordance with a further aspect of the invention, the objects are achieved by providing a method for manufacturing a filter housing, said method comprising introducing a plastic powder into a hollow mold corresponding to a housing part to be produced; heating the hollow mold to melt the plastic powder; rotating the hollow mold about equatorial and polar axes; cooling the mold to solidify the plastic, and opening the hollow mold and unmolding a unitary housing part comprising a plurality of housing sections integrally connected with each other such that the outside of at least one housing section is connected to the outside or the inside another housing section. Preferably, the method further comprises severing the housing sections from each other, and assembling the severed sections together to produce a sealed housing for accommodating a filter insert.

The filter housing according to the invention comprises an upper and a lower housing part, such that the two housing parts can be joined to form a seal. The housing parts can be attached to each other using screws or snap hooks, for example, although any other conventional connection types may, of course, be used. A seal member may be provided between the housing parts to seal the housing parts. The seal member contacts both housing parts.

A filter element may be inserted into the filter housing, which separates an unfiltered side enclosed by the filter housing from a filtered side, which is likewise enclosed by the housing. The filter element is used to filter a gaseous or liquid fluid. Fluids of this type include, for example, the air for the interior of a motor vehicle or the intake air for an internal combustion engine.

The housing parts are manufactured by centrifugal casting and have a geometrically defined outside and a geometrically undefined inside. The outside comes into direct contact with the mold so that the tolerances are relatively tight. The inside of the housing part does not contact the mold during manufacture and results from the wall thickness and the contour of the outside. As a result, the tolerances of the inside are relatively large. The geometrically defined outside of the one housing part is connected to the outside or inside of the other housing part.

The two housing parts each have a seal area configured to communicate with the seal area of the other part. Preferably, the seal area is configured as a seat in the one housing part and as an insert in the other housing part. The seat may be formed either by the outside or by the inside. The insert is the region of the housing part that engages in the seat. This insert can likewise be formed either by the outside and/or by the inside. This ensures an adequate seal of the filter housing.

Because the parts are produced by centrifugal casting, the costs for the molds are not as high as in injection molding, which is advantageous for small and very small series. In addition, it is also possible to manufacture bulky housing parts cost-effectively, e.g., air intake devices for commercial trucks.

According to one embodiment of the invention, at least one housing part is double-walled, such that the inside is at least partly enclosed by the outside. In another specific embodiment, the inside is completely enclosed by the outside, so that a closed volume results in the interior of the housing part. If both housing parts are double-walled, the geometrically exactly defined outsides of the two housing parts communicate with each other to provide an excellent seal and rigidity of the filter housing.

In an alternative embodiment of the invention, the lower housing part is produced integrally with the upper housing part in a centrifugal casting process. The two housing parts are mechanically separated after removal from the mold. In this case, it is also possible to remove a scrap piece from between the two housing parts. The advantage of this embodiment is that, on the one hand, producing the two housing parts simultaneously is less costly than producing them in two separate operations. On the other hand, it ensures that the geometries of the outside and the inside match exactly to provide an optimal fit and therefore an excellent seal.

The method for manufacturing a filter housing according to the invention includes at least the steps of filling a plastic powder into a hollow mold, heating, rotating, cooling and opening the hollow mold. After the hollow mold has been opened, the manufactured housing part is removed. The housing parts are then attached to each other, such that the outside of the one housing part is connected to the outside or the inside of the other housing part. This method makes it possible to produce low-cost housing parts with a proper fit and thus an excellent seal.

When the plastic powder is filled into the hollow mold, an exactly dosed amount is introduced. The plastic powder may be powdery or granular, for example. It may also have some other consistency that is suitable for a molding compound, including a liquid consistency. The plastic powder may have fillers added to it, such as carbon black, carbon fibers, glass beads or glass fibers, to increase the mechanical rigidity of the component to be produced and/or to improve its chemical resistance. The amount of plastic powder to be introduced depends on the size and the wall thickness of the component to be produced. A suitable material for the filter housing, for example, is polyamide. This material is especially suited for filter housings of motor vehicles because it is inexpensive and suitable for the conditions in motor vehicles.

Before the plastic powder is introduced, the hollow mold may be sprayed or coated with a parting agent to make the finished plastic component easier to remove from the mold. The hollow mold can be made of cast aluminum, steel or electroplated nickel or copper. The hollow mold, the inner surface of which produces the outer contour of the component to be formed, is heated. Heating can be done by a heating unit integrated into the hollow mold or by an external heat source. A heating unit integrated in the hollow mold, particularly into its wall, may be equipped with resistance wires, for instance.

The hollow mold must be heated to a temperature at which the introduced charge of plastic powder melts and is uniformly distributed about the polar and equatorial axes of the inner surface of the hollow mold as a result of the rotation of the mold. The hollow mold may, for instance, be rotated at approximately 5 rotations per minute. This makes it possible to produce nearly uniform wall thicknesses in the component.

When all of the plastic powder has melted and been distributed uniformly inside the hollow mold, the hollow mold is cooled again, so that the melt solidifies and the component can form. Cooling of the hollow mold must be controlled in such a way that the component is cooled uniformly and excessive warping by shrinkage is avoided. When the component has sufficiently cooled, the hollow mold is opened at the parting lines of the mold provided for this purpose and the component is removed.

After complete cooling of the component, the housing parts can be assembled into the filter housing. If necessary, the housing parts may be machined in addition. Machining of this type may include, for example, creating an inlet or outlet opening for the fluid to be filtered. During assembly, the outside of the one component is mounted to the inside or outside of the other component. This provides an optimal seal between the components.

Only the outside of the components produced by centrifugal casting is in contact with the hollow mold during the manufacturing process. The inside of the component has no direct contact to the hollow mold. As a result, the inside does not have a defined shape.

In yet another advantageous embodiment of the method of the invention, the two housing parts are produced in one piece in a single hollow mold. After the entire housing part has been removed from the mold, it is divided into two or more housing parts. This separation produces the individual housing parts.

As the housing parts are divided, scrap pieces, which connected the individual housing parts when the entire housing part was manufactured, may be produced. The role of these scrap pieces during production of the entire housing part is merely to link the two housing parts to each other. The junction between the housing parts is configured in such a way that the melt contained in the hollow mold can flow to every point. Large shoulders should be avoided.

It is advantageous to use polyethylene or polypropylene for the plastic powder. These materials are very inexpensive and lend themselves well to centrifugal casting. They are also water resistant.

In a specific embodiment of the invention, the housing parts are releaseably interconnected by clips, screws or the like. This releasable connection of the housing parts simplifies a replacement of the filter element which is inserted in the filter housing.

### BRIEF DESCRIPTION OF THE DRAWINGS

The invention will be described in further detail hereinafter with reference to illustrative preferred embodiments shown in the accompanying drawing figures, in which:

FIG. 1 is a schematic sectional representation of a complete molded housing part according to the invention;

FIG. 2 is a sectional view of a filter housing according to the invention;

FIG. 3 is a sectional view of a double-walled upper housing part according to the invention, and

FIG. 4 is a sectional view of a double-walled lower housing part.

### DETAILED DESCRIPTION OF PREFERRED EMBODIMENTS

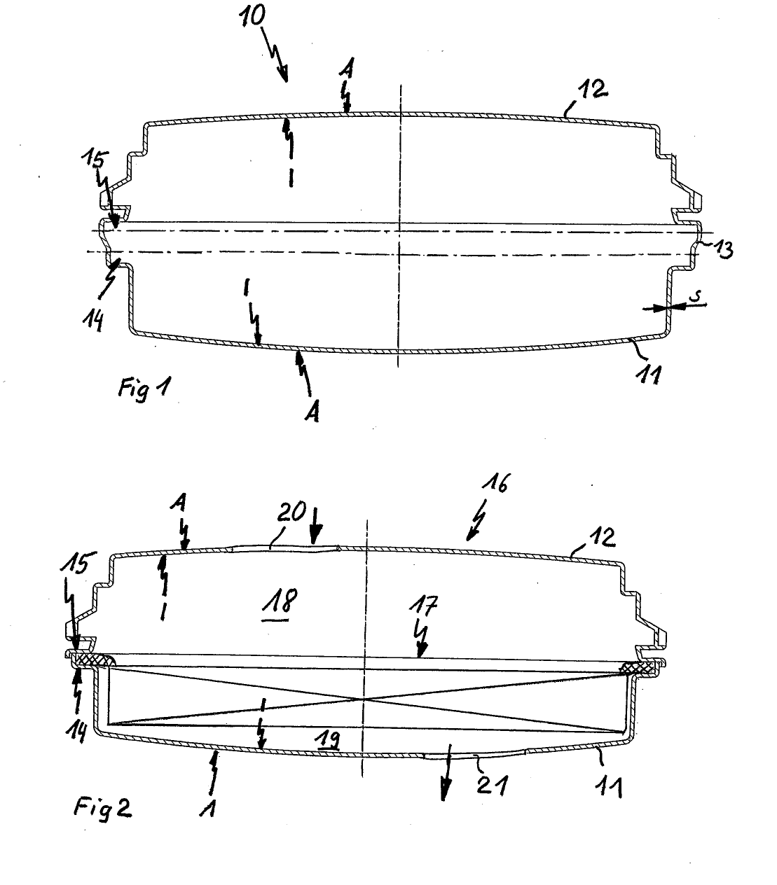

FIG. 1 is a sectional view of a complete housing part 10. The complete housing part 10 is produced in a hollow mold (not shown) as a large, hollow one-piece component having a wall thickness “s”. The wall thickness “s” is nearly constant in the entire housing part 10 and extends between an outside “A” and an inside “I”. The complete housing part 10 includes a region which forms the lower housing part 11. Another region forms the upper housing part 12. The two housing parts 11, 12 are connected along the broken (dash-dot) lines by a scrap piece 13.

The geometries of the housing parts 11, 12 are designed to interlock after the scrap piece 13 has been removed and so that the upper and lower housing parts 11, 12 can be connected to form a seal. To this end, the lower housing part 11 has an insert 14 that is geometrically formed by the outside A of the lower housing part 11. The upper housing part 12 has a recess 15, which receives the insert 14 after the scrap piece 13 has been removed. The recess 15 is geometrically formed by the inside I of the upper housing part 12.

FIG. 2 is a sectional view of a filter housing 16. Components corresponding to those of FIG. 1 are identified by the same reference numerals. The filter housing 16 comprises an upper housing part 12 and a lower housing part 11. A filter element 17 is arranged in the lower housing part 11. The filter element 17 is inserted between the lower housing part 11 and the upper housing part 12 in such a way that a seal is formed, so that an unfiltered side 18 of the filter is separated from a filtered side 19. The unfiltered side 18 is located in the upper housing part 12, which comprises an inlet 20 that is formed in the upper housing part 12 by mechanical machining. The filtered side 19 is located in the lower housing part 11, which has an outlet 21 that was likewise formed by machining the lower housing part 11. The inlet 20 and the outlet 21 can of course also be produced when the housing part is manufactured by a constructing the mold with an appropriate inlet and outlet forming geometry. The fluid to be filtered flows through the inlet 20 into the filter housing 16 as indicated by the arrow, is filtered by the filter element 17 and then flows through the outlet 21 out of the filter housing 16, again in the direction of the arrow.

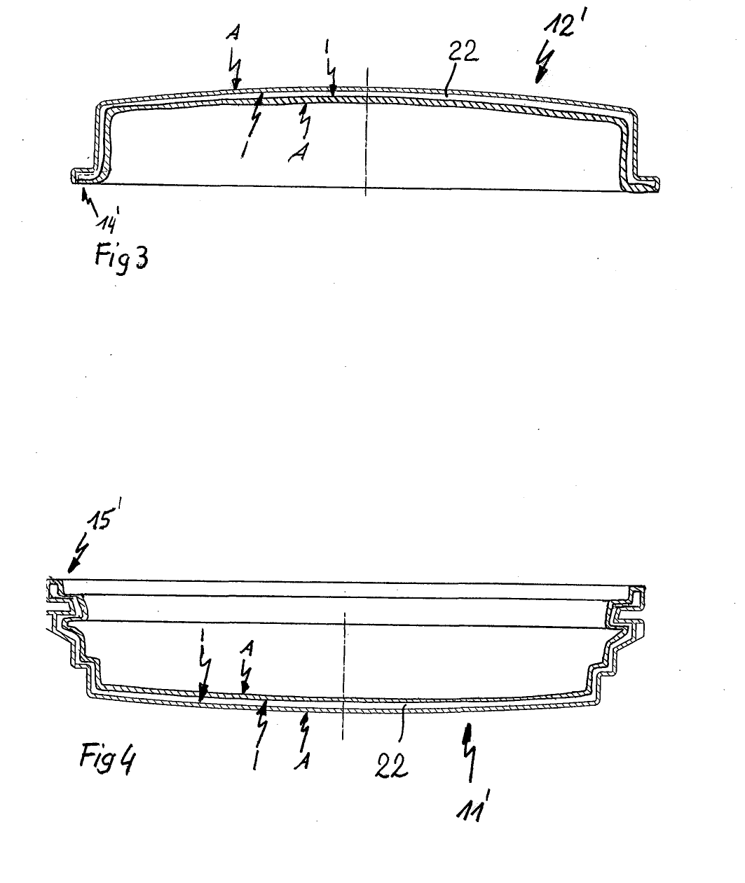

FIG. 3 is a sectional view of a double-walled upper housing part 12′. In this upper housing part 12′, the outside A′ is configured in such a way that it encloses the inside I′ on all sides. Thus, the upper housing part 12′ has an outside A′ on all sides with tight tolerances geometrically defined by the hollow mold. These tight tolerances define the geometry of the insert 14′ exactly and are not subject to the wall thickness fluctuations of the housing part 12′. The inside I′ encloses a closed inner volume 22, which receives no flow. This inner volume 22 has acoustic properties that can muffle the intake noise of an internal combustion engine. Because of its double-wall construction, this upper housing 12′ also has greater rigidity.

FIG. 4 shows the lower housing part 11′, which is likewise double-walled. Components corresponding to those in FIG. 3 are identified by the same reference numerals, and the foregoing explanations regarding the outside A′, the inside I′ and the inner volume 22 also apply to the lower housing part 11′. The recess 15′, like the insert 14′ shown in FIG. 3, is formed completely by the outside A′. Thus, the recess 15′ has an exactly defined geometric contour. A filter element (not shown) can be inserted into this recess 15′ and fixed by the insert 14′ of the upper housing part 12′.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A method for manufacturing a filter housing, said method comprising:
introducing a plastic powder into a hollow mold corresponding to a housing part to be produced;
heating the hollow mold to melt the plastic powder;
rotating the hollow mold about equatorial and polar axes;
cooling the mold to solidify the plastic, and
opening the hollow mold and unmolding a unitary housing part comprising a plurality of housing sections integrally connected with each other such that the outside of at least one housing section is connected to the outside or the inside another housing section.

2. A method according to claim 1, further comprising:
severing the housing sections from each other, and
assembling the severed sections together to produce a sealed housing for accommodating a filter insert.

3. A method according to claim 1, wherein said plastic powder is polyethylene or polypropylene.

4. A method according to claim 1, wherein the assembled housing sections are connected clips or screws.

5. A method according to claim 1, wherein a scrap piece is removed from between the housing parts.
